(19) United States
(12) Patent Application Publication
(10) Pub. No.: US 2013/0101369 A1
(43) Pub. Date: Apr. 25, 2013

(54) TRIPPED UNLOCKING DEVICE, CONNECTING TWO DETACHABLE SUBASSEMBLIES

(71) Applicants: Charlotte Lenoir, Carrieres sous Poissy (FR); Bertrand Haguenauer, Le Celle Saint-Cloud (FR); Christian Forys, Auvers sur Oise (FR)

(72) Inventors: Charlotte Lenoir, Carrieres sous Poissy (FR); Bertrand Haguenauer, Le Celle Saint-Cloud (FR); Christian Forys, Auvers sur Oise (FR)

(73) Assignee: PYROALLIANCE, Les Mureaux (FR)

(21) Appl. No.: 13/696,754

(22) PCT Filed: May 5, 2011
(86) PCT No.: PCT/FR11/51026

§ 371 Date: Jan. 10, 2013

(30) Foreign Application Priority Data
May 7, 2010 (FR) 1053609

(51) Int. Cl. B64G 1/64; F16B 31/00

(52) U.S. Cl. CPC B64G 1/645; F16B 31/00
USPC 411/2

(57) ABSTRACT

A device for rapidly separating two subassemblies under the action of a pyrotechnic gas generator. The device comprises a segmented nut (17) held by a release sleeve (40) that is movable under the action of the gas generator (15), a drive chamber (64) including an end wall of the release sleeve, a damping chamber (66) communicating with a gas expansion chamber (60), and calibrated passages (70) extending between the damping chamber and the drive chamber.

The invention relates to a triggered unlocking device used for assembling together two subassemblies, said device being suitable, on being triggered, for causing them to be separated. Triggering is typically caused by igniting a pyrotechnic gas generator. The invention seeks to simplify the technology of such a device and to improve its reliability.

A privileged field of application of the invention is that of separating articles such as a satellite relative to a carrier structure, in order to place said satellite on its orbit by using a rocket. The device enables the satellite to be unlocked from its support and to move quickly away therefrom.

Document FR 2 807 123 discloses a device of the above-mentioned type that essentially comprises a gas generator, a body in which an expansion chamber is defined for the gas delivered by the gas generator, a segmented nut arranged inside a release sleeve that is movable in said body, and a connection screw having a threaded portion engaged in the nut. The two subassemblies for separating are assembled between the body and the head of the screw. By moving longitudinally after triggering, i.e. after gas has been injected under pressure into said expansion chamber, the sleeve allows the segments of the nut to move apart from one another, thereby leading to instantaneous release of said connection screw (without any unscrewing).

The screw is expelled by means of an axial ejector that is itself propelled by the gas.

A specific feature of such a system lies in the fact that triggering the locking device makes it possible in a preliminary stage to create a damping device for braking the release sleeve effectively before it reaches a rigid mechanical stop, which would otherwise lead to a major impact, but without significantly slowing down the operation of the device. In that way, by avoiding a sudden mechanical impact, the pieces of equipment connected to the structure associated with the nut are preserved. The two subassemblies are thus separated cleanly but not roughly. The separation needs to take place in a very short length of time. It is therefore inappropriate to slow down the operating mechanism of the device solely for the purpose of avoiding that mechanical impact at the end of its stroke. The appropriate damping means described in the above-mentioned document serve to avoid any disturbance due to a sudden impact while keeping a high level of performance for the unlocking device, in particular concerning its response time.

Nevertheless, the prior art device is complex and expensive both in terms of the arrangement of the damping means and in terms of the presence of the axial ejector. The invention proposes a device that is simpler, with performance that is at least equivalent, in which the stroke of the release sleeve is controlled while avoiding any sudden end-of-stroke impact, and the ejector is omitted.

More particularly, the invention provides a triggered unlocking device connecting together two detachable subassemblies, the device comprising a body, an expansion chamber defined in said body and receiving the gas delivered by a gas generator when the generator is triggered, a segmented nut made up of segments touching one another longitudinally prior to said triggering in order to make up a tapped bore, a release sleeve for releasing said segmented nut arranged around said nut, and shaped to slide in a bore of said body and to enable said segments to be moved apart during said triggering, a connection screw having a threaded portion engaged in said nut, said subassemblies being assembled between said body and said connection screw, and a piston-forming pusher mounted so as to be capable of sliding in an axial bore of said release sleeve and including an actuation end shaped to co-operate with end surfaces of said segments, the device being characterized in that it further comprises a drive chamber defined between said body and an end wall of said release sleeve adjacent to said expansion chamber, in that a damping chamber communicating with said expansion chamber is defined inside a bore of said release sleeve between an end wall thereof and the end of said pusher remote from said actuation end, and in that calibrated passages are defined in the side wall of said release sleeve between said damping chamber and said drive chamber.

Advantageously, the arrangement is such that at the beginning of the stroke of said sleeve, the drive chamber communicates with the expansion chamber only via said damping chamber, and consequently via said calibrated passages, of small action.

For example, the release sleeve includes an extension forming a duct opening out into the damping chamber and slidably engaged in a bore of a wall of said body separating said expansion chamber from said drive chamber.

Optionally, direct communication is established between the expansion chamber and the drive chamber when the release sleeve moves. This depends on the length of the extension on the release sleeve that is slidably engaged in a bore of a wall of said body.

According to another characteristic, the drive chamber includes an annular portion defined by a shoulder of said body, which portion extends and enlarges the bore of the body in which said release sleeve slides. The above-mentioned calibrated passages are spaced apart along the side wall of said sleeve in order to enable the gas flow section between said damping chamber and said drive chamber to be reduced progressively as the release sleeve moves, i.e. progressively as the calibrated passages are shut off on going beyond said shoulder.

Optionally, the pusher includes a shutter projecting into said damping chamber and shaped and dimensioned to engage in and shut off said duct of said release sleeve at the end of its stroke. This option may apply when the damping is found to be too strong or the drive power, as defined in this way, is found to be too weak.

The invention can be better understood and other advantages thereof can be seen more clearly in the light of the following description of an embodiment of an unlocking device in accordance with the principle of the invention and given solely by way of example, with reference to the accompanying drawings, in which:

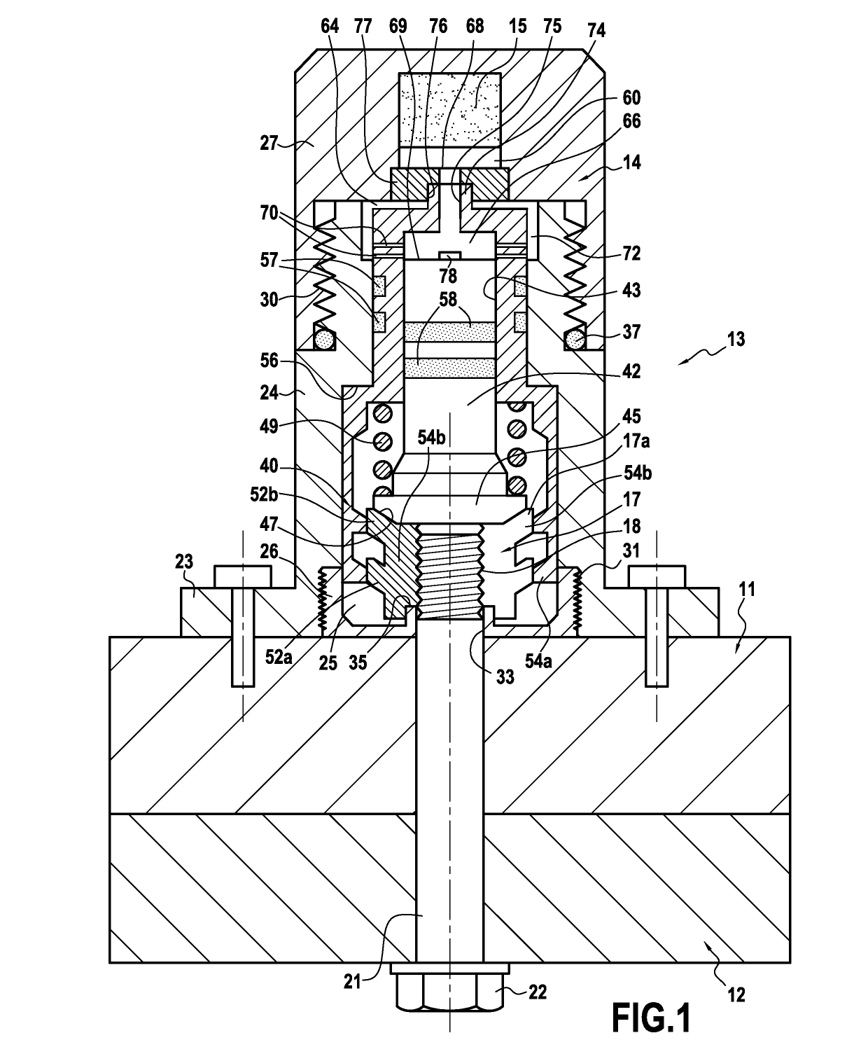

FIG. 1 is an elevation view in section of the device, before being triggered, connecting together two detachable subassemblies; and

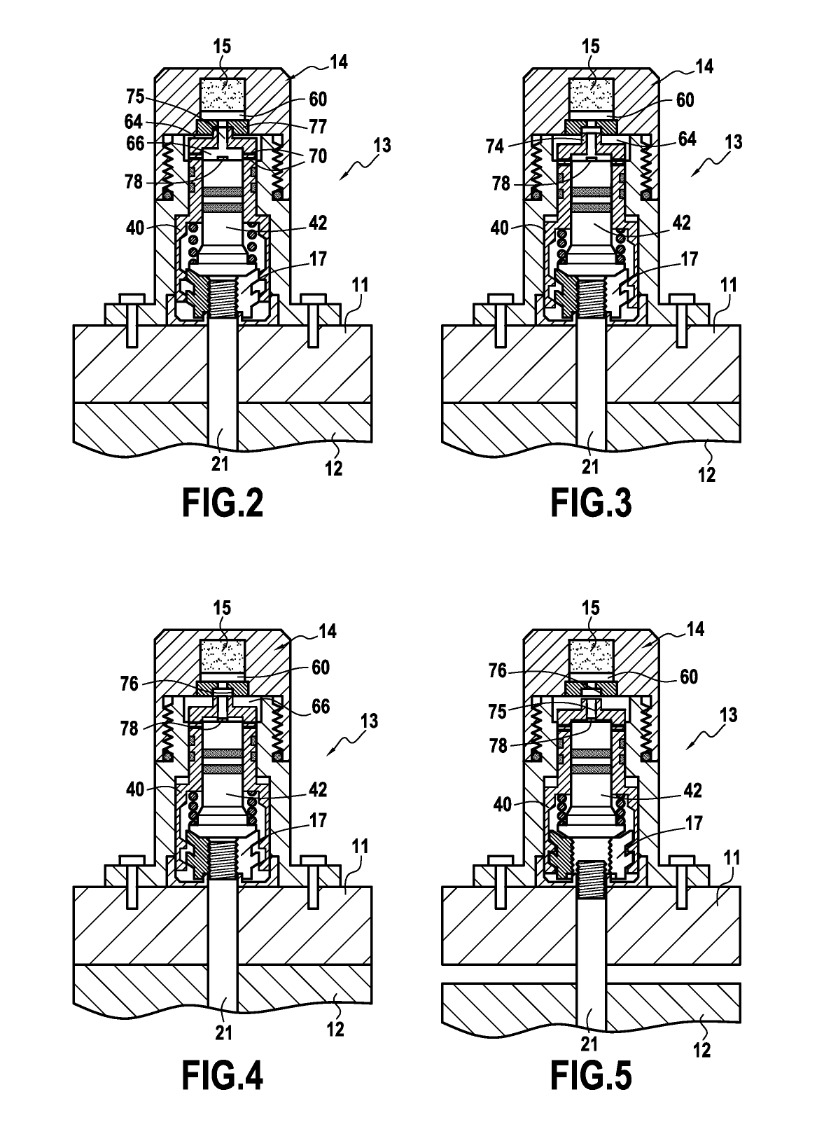

FIGS. 2 to 5 are diagrammatic views showing the different stages in the operation of the device after the gas generator has been triggered.

With reference to the drawings, there are shown in highly diagrammatic manner two subassemblies 11 and 12 that are assembled together by a pyrotechnically actuated system referred to below as a “triggered unlocking device” 13, given that its function is to enable the two subassemblies to be separated rapidly after holding them assembled together, prior to a gas generator being triggered.

More precisely, said unlocking device 13 comprises a body 14 housing a gas generator 15, here a pyrotechnically actuated generator, a segmented nut 17 made up of segments 17a that touch one another longitudinally (before said pyrotechnic triggering) serving to make up a tapped bore 18, and a connection screw 21 having a threaded portion engaged in the tapped bore 18 of the nut.

As shown, before triggering, the two subassemblies 11 and 12 are tightly assembled together between the body 14 and the connection screw 21. The screw head 22 bears against the subassembly 12, passes through two aligned holes in the subassemblies 11 and 12 and is screwed into the nut 17. The body 14 has a base 23 screwed onto the subassembly 11. It is generally cylindrical and hollow and includes a middle segment 24, a slab 26, and a cap 27. Said middle segment 24 is extended by the base 23. It includes an outside thread 30 and an inside thread 31. The inside thread receives the footing 26 which has an outside thread and which is received in the vicinity of the base 23. The footing 26 includes a bore 33, here an axial bore, for passing the screw, and it also has an annular groove 25. An annular rim 35 is defined between the bore 33 and the groove 25. Before triggering, the segments of the nut 17 rest against this rim.

The cap 27 has an inside thread and is screwed onto the outside thread 30 of the middle segment, with a sealing gasket 37 interposed between them. This subdivision of the body 14 into three elements is made necessary by the need to define a plurality of shoulders inside the body in simple manner, as described below, while also enabling the other component parts to be assembled easily.

The body 14 as defined in this way also houses a release sleeve 40 suitable for sliding axially in the body and a piston-forming pusher 42 mounted so as to be capable of sliding in an axial bore 43 of said release sleeve. The pusher has an actuation end shaped to co-operate with end surfaces of the segments of the nut. More precisely, this end forms a head with a frustoconical wall 45 that bears against complementary frustoconical surfaces 47 defined at the facing ends of the segments 17a of the nut. Said head 45 is urged to press against said complementary frustoconical surfaces 47 by a spring 49 mounted with prestress between an internal shoulder of the release sleeve 40 and a shoulder of the pusher 42.

Furthermore, the nut 17 has two axially spaced apart outer peripheral ribs 52a and 52b (which ribs are consequently segmented like the nut itself), while the release sleeve 40 also includes two internal peripheral ribs 54a and 54b against which the ribs of the nut come to bear respectively when the nut is made up as a nut (i.e. prior to triggering), and while it is holding the screw 21. The rib 54a defined at one end of the sleeve is suitable for engaging in the annular groove 25 of the footing.

Prior to triggering, the release sleeve 40 bears against an internal shoulder 56 of the middle segment of the body, under drive from the spring 49.

At this stage of the description, it can be understood that if the release sleeve 40 moves (downwards in FIG. 1), its end engages in the annular groove 25 of the footing that is in line with the bore in which the release sleeve slides.

As a result, respective contacts between the outer ribs 52a, 52b of the nut and the inner ribs 54a, 54b of the sleeve disappear, and the segments of the nut move apart suddenly in a radially outward direction under drive from the pusher 42, thereby releasing the screw 21 almost instantaneously.

The release sleeve has two sliding gaskets 57 in contact with the smaller diameter portion of the bore defined in the middle segment 25 of the body. The pusher 42 also has two sliding gaskets 58 in contact with the inside wall of the release sleeve.

The gas generator 15 is housed in the cap 27 of the body. In this example, it is a gas generator comprising a pyrotechnically actuated charge. Its gas expulsion outlet communicates with a gas expansion chamber 60 defined in line with the gas generator.

Furthermore, the various above-described subassemblies are shaped in such a manner that the device also includes a drive chamber 64 defined between said body and an end wall of said release sleeve adjacent to the expansion chamber, and a damping chamber 66 communicating with said expansion chamber. The damping chamber 66 is defined inside the bore of the release sleeve between an end wall 68 thereof and the end 69 of the pusher 42 that is remote from its said actuation end co-operating with the nut. Furthermore, calibrated passages 70 are defined in the side wall of the release sleeve 40 between said damping chamber 66 and said drive chamber 64.

More precisely, the drive chamber 64 includes an annular portion 72 defined by a shoulder of the body 14, extending and enlarging the bore in the body in which said release sleeve slides. The calibrated passages 70 are spaced apart along the side wall of the sleeve. These parallel calibrated passages 70 are spaced apart in the axial direction of the release sleeve such that they are closed in succession as the release sleeve moves, thereby serving, as this movement takes place, to reduce progressively the flow section for the gas between the damping chamber 66 and the drive chamber 64.

In addition, said release sleeve 40 includes an extension 74 forming a duct 75 that opens out into the damping chamber 64, and this extension is slidably engaged in a bore 76 of a wall 77 separating said expansion chamber 60 from said drive chamber 64.

Consequently, at the beginning of the stroke of said release sleeve, said drive chamber 64 communicates with the expansion chamber 60 only via the damping chamber 66, through the calibrated passages 70.

In this example, the pusher 42 has a shutter 78 projecting into the damping chamber and shaped and sized so as to engage in and shut off the duct 75 of said release sleeve at the end of its stroke, in order to establish a direct and single connection between said gas expansion chamber 60 and said drive chamber 64. This option is advantageous when damping is considerable or when drive power is weak, as mentioned above.

Operation stems clearly from the above description and is described below with reference to FIGS. 2 to 5.

Before pyrotechnic triggering and at the very beginning of the stroke of the release sleeve 40, the extension forming a duct 75 defined at the end of the release sleeve is engaged in the wall 77 defining the gas expansion chamber; this is a situation shown in FIG. 2. Immediately after triggering, gas penetrates into the damping chamber 66 and passes through the calibrated orifices 70 in order to be able to act on the end face of the release sleeve 40. The strong expansion of the gas therefore does not give rise to a sudden movement of the release sleeve because of the gas flow constrictions through the calibrated passages 70. Furthermore, as can be seen in FIG. 3, as the release sleeve 40 continues to move, the number of calibrated passages 70 through which the gas can penetrate into said drive chamber decreases, thereby contributing to controlling the movement of the release sleeve. Then, when all of the calibrated passages 70 have been shut off (FIG. 4), there is no longer any communication between the damping chamber 66 and the drive chamber 64. In this example, the extension 74 of the release sleeve separates from the bore 76, thereby enabling a direct connection to be established between the expansion chamber 60 and the drive chamber 64. In addition, the shutter 78 projecting into the damping chamber engages in and shuts off the duct 75 in the release sleeve, thereby ensuring sufficient drive pressure for terminating the movement. During this time, the segments 17a of the nut 17 move apart and release the screw 21, thus enabling the two subassemblies 11 and 12 to be separated

In another possible embodiment that depends on the damping conditions and on the drive power of the gas generator, there is no direct communication established between the gas expansion chamber 60 and the drive chamber 64 when the release sleeve 40 moves. This depends on the length of the extension 74.

1. A triggered unlocking device connecting together two detachable subassemblies the device comprising a body, an expansion chamber defined in said body and receiving the gas delivered by a gas generator when the generator is triggered, a segmented nut made up of segments touching one another longitudinally prior to said triggering in order to make up a tapped bore, a release sleeve for releasing said segmented nut arranged around said nut, and shaped to slide in a bore of said body and to enable said segments to be moved apart during said triggering, a connection screw having a threaded portion engaged in said nut, said subassemblies being assembled between said body and said connection screw, and a piston-forming pusher mounted so as to be capable of sliding in an axial bore of said release sleeve and including an actuation end shaped to co-operate with end surfaces of said segments, wherein the device further comprises a drive chamber defined between said body and an end wall of said release sleeve adjacent to said expansion chamber, wherein a damping chamber communicating with said expansion chamber is defined inside a bore of said release sleeve between an end wall thereof and the end of said pusher remote from said actuation end, and wherein calibrated passages are defined in the side wall of said release sleeve between said damping chamber and said drive chamber.

2. A device according to claim 1, wherein said release sleeve includes an extension forming a duct opening out into the damping chamber and slidably engaged in a bore of a wall of said body between said expansion chamber and said drive chamber, such that at the beginning of the stroke of said sleeve, said drive chamber communicates with the expansion chamber solely via said damping chamber.

3. A device according to claim 2, wherein said pusher includes an axial shutter projecting into said damping chamber and shaped and sized to engage therein and to shut off said duct of said release sleeve at the end of its stroke in order to establish a single and direct connection between said expansion chamber and said drive chamber.

4. A device according to claim 1, wherein said drive chamber includes an annular portion defined by a shoulder of said body, extending and enlarging said bore of the body in which said release sleeve slides, and in that the above-mentioned calibrated passages are spaced apart along the side wall of said sleeve to enable the gas flow section between said damping chamber and said drive chamber to be reduced progressively as said release sleeve moves.

5. A device according to claim 1, wherein a spring is housed between said release sleeve and said actuation end of said pusher.
